(19) United States
(12) Patent Application Publication
(10) Pub. No.: US 2009/0188690 A1
(43) Pub. Date: Jul. 30, 2009

(54) AUTO CLEAT DRIVER

(76) Inventor: Robert Wayne Rodola, JR., Chandler, AZ (US)

Correspondence Address: Robert Wayne Rodola JR., 14109 N. 83rd Ave., Peorla, AZ, 85381, US

(21) Appl. No.: 12/022,153

(22) Filed: Jan. 30, 2008

(51) Int. Cl. B25D 11/00

(52) U.S. Cl. 173/117

(57) ABSTRACT

The present invention is an operatively connectable hammer tool that is sole-operated by an electric-hammer. The said invention is to forcibly guide the drive cleat in the joining of two rectangular sheet metal ducts. Wherein the slot having parallel sides with horizontal restrictions operatively connectable to an electric hammer as means of forcibly guiding the drive-cleat, Where as the slot having two parallel sides with cross-drilled openings as means to connect the said invention to the said drive cleat, using vibrations energized by an electric hammer to hook and drag, removing the said drive cleat.

### FIELD OF THE INVENTION

The present invention is an operative connectable hammer tool for an electric hammer. The tool is used to accurately and forcibly drive an elongated flat-like member, with consistent striking movements controlled by an electric hammer or of the like, said apparatus comprising:

### BACKGROUND OF THE INVENTION

The present invention relates generally to devices or apparatus for urging flat-like members. The present invention is said to join rectangular joints of sheet metal for the use of Heating Ventilation and Air-Condition (HVAC).

Assembling rectangular duct properly requires 3 parts. One is the joints of rectangular duct assembled to direct air-flow. Two, is the S or standing-S used to stabilize the alignment of multiple joints of duct work. Third, is the drive cleat, the drive cleat is said to be the connecting material of two rectangular pieces of duct work.

Therefore, In the past sheet metal cleat-drives for assembling joints of rectangular duct have been forced or driven on by a hammer or similar medium pounding on, or otherwise imparting impact blows on the end of the cleat-drive with a sledge hammer or other similar tool.

Such methods have proven to be inconvenient and unsafe, especially where the cleat-drive or flat-like member is relatively long, due to demand in air flow the rectangular duct will vary in size. The worker imparting such impact blows would experience resistance or bending of the cleat-drive the greater the size of duct.

In addition, such methods frequently required the worker to hold the cleat-drive. Therefore, in the event of an inaccurate or errant impact blow, injury to the holder frequently resulted.

Such methods also made it difficult to avoid bending, nicking, or otherwise damaging the drive. More specifically, the invention relates to such devices or apparatus having a slot for striking action. Whereas the invention guides (page 5) the drive cleat, through striking movements and or vibrations energized by the electric hammer, thus increasing productivity and efficiency. Whereas the worker imparting such impact blows would result in an injury or be exhausted from the swinging of a hammer.

Therefore not having to hold and manually pound on the cleat-drive. The driving force to the apparatus by use of power percussion tools or the like.

### DETAILED DESCRIPTION OF THE INVENTION

The present invention is operatively connectable 10 to an electric-hammer 18. The invention is constructed of metal to with stand the constant striking impacts 12 produced by an electric-hammer 18, whereas the guide slot 12 is the receiving end 10 of a flat like member as means of guiding 12 while impacting 10 in conjunction with both the electric hammer 18 and the said guide slot 12, wherein the slot has parallel sides 14,16, comprising of 12 horizontal restrictions evenly straight or extending outward as means to receive 8 a flat-like member.

The said guide slot 12, allows tilting of the electric-hammer and projection extending into a respective guide slot 10 to cooperate upon movement of said body with out dis-placement of the drive cleat.

The said invention has a rod 10 short in range vertically centered at the bottom of the said slot 12. The said rod is operatively connectable 10 to an electric hammer 18 and solid within itself to withstanding the impact and percussion of an electric-hammer.

Wherein the slot has parallel sides. The said parallel sides has restrictions (FIG. 3) to horizontal movement within the slot.

The said parallel sides 17 allows tilting and projection extending into a respective guide slot 8 to cooperate upon movement of said body with out displacement of the cleat-drive or flat-like member, when forced in a forward motion through consistent striking movements 18.

The said parallel sides having equally centered cross-drilled 17 openings, said as means to temporarily lock, the said invention to the cleat-drive or flat like member during the removal process.

The cross-drilled slot 17 has been sized to allow the manual inserting of the cleat-drive. Once the cleat-drive's inserted into the cross-drilled opening followed by said tilting the electric-hammer parallel to the drive cleat, therefore temporally securing the said invention to the said drive cleat.

The electric hammer 18 will than remove the drive cleat through striking movements and or vibrations energized by the electric hammer.

### BRIEF DESCRIPTION OF DRAWINGS

FIG. 1 is a first perspective view of a auto cleat driver in accordance with the present invention;

FIG. 2 is a second perspective view of a auto cleat driver;

FIG. 3 is a side view of a auto cleat driver;

FIG. 4 is an end view of a auto cleat driver;

FIG. 5 is a side view of a auto cleat driver operatively connected to an electric hammer.

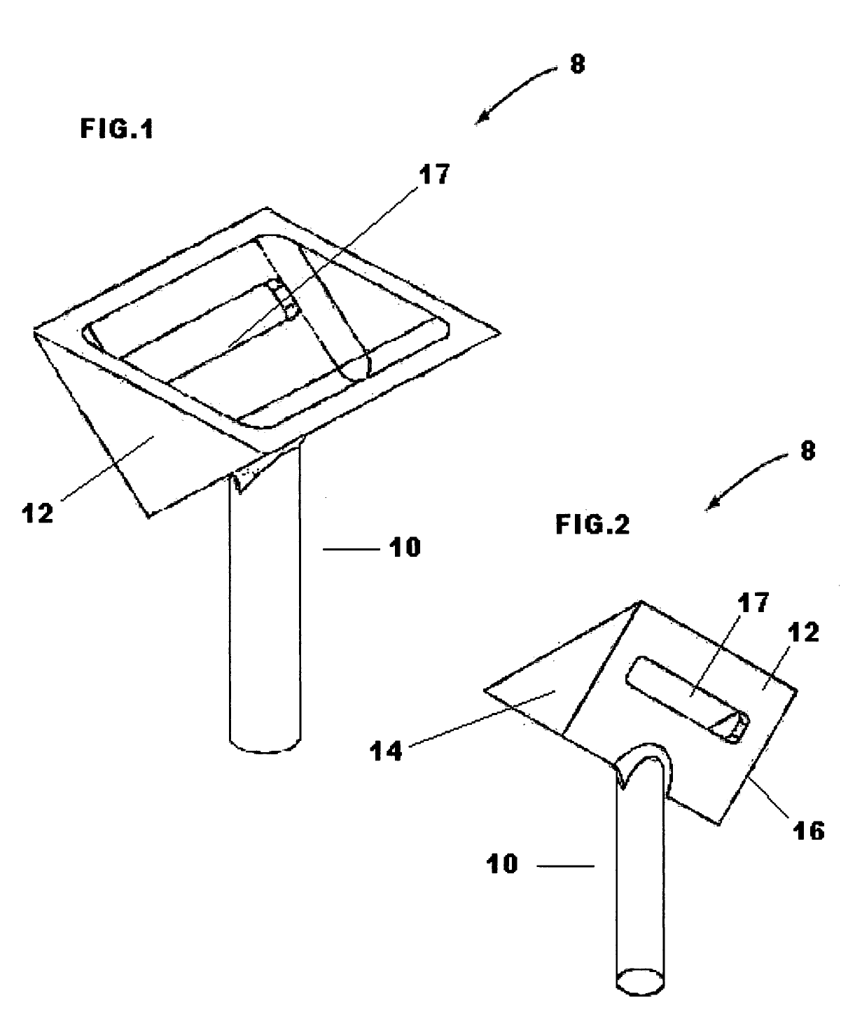

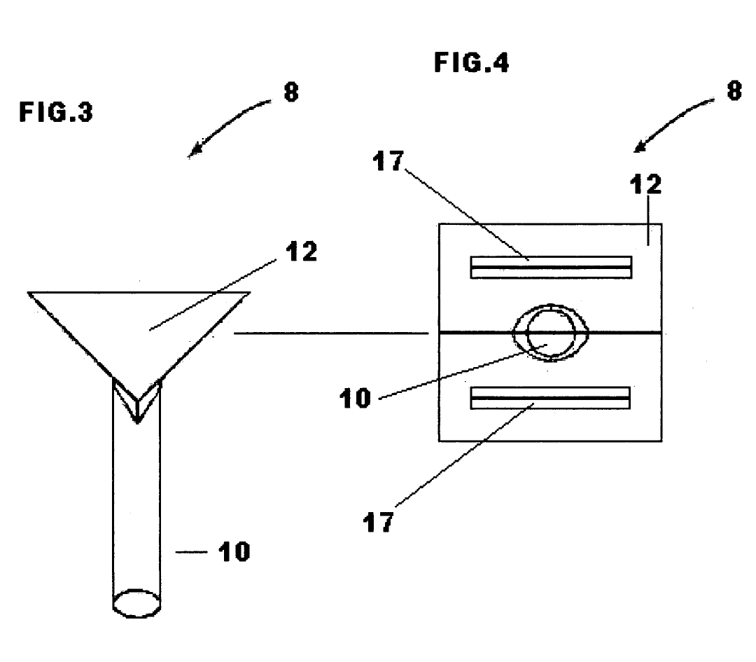

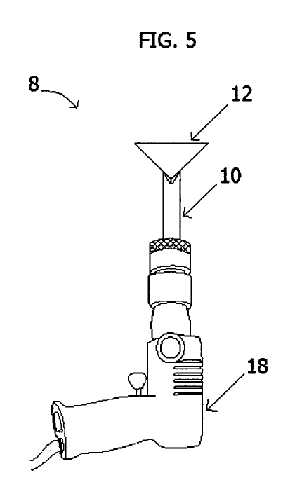

1. The Present invention an operatively connectable hammer tool for an electric-hammer comprising a operatively connectable rod; a slot having four sides, wherein the slot has two parallel sides projecting outward from said bottom to said top. Where in the slot imparts the impact restricting horizontal movement, said boundaries. Whereas parallel Cross-drilled openings are means to attach.
The invention found in claim 1 whereas the rod is vertical in length to that of the slot.
The invention found in claim 2 wherein the slot has two parallel sides.
The invention found in claim 3 wherein the slot imparts the impact.
The invention found in claim 4 wherein the slot restricts movement.
The invention found in claim 5 whereas the cross-drilled openings are means to attach.
